(19) United States
(12) Patent Application Publication
(10) Pub. No.: US 2026/0012585 A1
(43) Pub. Date: Jan. 8, 2026

(54) SPATIAL GEOMETRIC PARTITIONING FOR MOTION PREDICTION

(71) Applicant: Alibaba (China) Co., Ltd., Hangzhou (CN)

(72) Inventors: Xinwei Li, Beijing (CN); Ru-ling Liao, Sunnyvale, CA (US); Jie Chen, Beijing (CN); Yan Ye, San Diego, CA (US)

(21) Appl. No.: 19/259,982

(22) Filed: Jul. 3, 2025

Related U.S. Application Data
(60) Provisional application No. 63/667,574, filed on Jul. 3, 2024.
(60) Provisional application No. 63/688,620, filed on Aug. 29, 2024.

(51) Int. Cl. H04N 19/11; H04N 19/105; H04N 19/174; H04N 19/176

(52) U.S. Cl. CPC H04N 19/11; H04N 19/105; H04N 19/174; H04N 19/176

(57) ABSTRACT

A Versatile Video Coding (“VVC”) and later standard encoder and a VVC and later standard decoder are provided, and a third-generation Audio and Video coding standard (“AVS3”) and later standard encoder and an AVS3 and later standard decoder are provided configuring one or more processors of a computing system to perform spatial geometric partitioning, including extension of regression spatial geometric partitioning mode (“SGPM”) to intra prediction; fusion of SGPM with multiple intra prediction modes; adaptive blending area size for SGPM; conditional matrix-based intra prediction for SGPM; and implementing any or all of the preceding for angular weighted prediction (“AWP”).

### CROSS REFERENCE TO RELATED PATENT APPLICATIONS

This application claims priority to and benefit of U.S. Provisional Application No. 63/667,574, filed on Jul. 3, 2024, and entitled “IMPROVEMENTS TO SPATIAL GEOMETRIC PARTITIONING FOR MOTION PREDICTION,” and claims priority to and benefit of U.S. Provisional Application No. 63/688,620, filed on Aug. 29, 2024, and entitled “IMPROVEMENTS TO SPATIAL GEOMETRIC PARTITIONING FOR MOTION PREDICTION,” which are incorporated herein by reference in their entirety.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET developed further techniques beyond the scope of the VVC standard under the Enhanced Compression Model (“ECM”) name, which has formed the basis for the successor H.267 standard currently in draft status.

According to VVC and later standards, an encoder and a decoder partition picture data into blocks, and perform motion prediction upon luma and chroma components of the blocks by selecting one among various intra prediction and inter prediction modes. VVC and later standards provide Geometric Partitioning Mode (“GPM”), where, to efficiently code boundaries and edges of objects in a picture, any particular block of a picture can be internally partitioned into two irregular partitions by a partitioning line spanning two edges of the block.

Moreover, ECM extends GPM as Spatial Geometric Partitioning Mode (“SGPM”), utilized in intra prediction: SGPM partitions a coding block into two parts according to a partition mode and predicts each part by a intra prediction mode.

Additionally, the Audio and Video coding standard workgroup (“AVS workgroup”) in China has adopted the third-generation Audio and Video coding standard (“AVS3”). AVS3 was preceded by AVS1 and AVS2, issued as China national standards in the years of 2006 and 2016, respectively. AVS3 provides angular weighted prediction (“AWP”), a tool similar to GPM. Presently, the AVS workgroup is reviewing draft proposals for subsequent improvements over AVS3 techniques to be included in the successor AVS4 standard.

There is a need to further improve the implementation of SGPM as provided by ECM, as well as AWP as provided by GPM.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, a video encoding process and a video decoding process according to example embodiments of the present disclosure.

FIG. 2 illustrates classifications of geometric partitions by angle.

FIG. 3 illustrates an example blending weight w₀ derived for position (x, y).

FIG. 4 illustrates ramp functions for additional blending area sizes based on the ramp function of an original blending area size.

FIG. 5 illustrates an example of a partition splitting line of a current coding unit (“CU”).

FIGS. 6A through 6C illustrate respective examples of the available intra prediction mode (“IPM”) candidates.

FIG. 6D illustrates GPM with intra and intra prediction.

FIG. 7 illustrates coordinate positions of the current sample (x, y) relative to the top-left position within the current block.

FIG. 8 illustrates angular intra prediction modes according to VVC and later standards, where modes added in VVC are illustrated in broken lines.

FIG. 9 illustrates four corner samples of the current block.

FIG. 10 illustrates adjacent blocks which can be added to most probable mode (“MPM”) lists.

FIG. 11 illustrates a L-shaped causal neighborhood template whose reference samples are weighted in a matrix-based intra prediction mode.

FIG. 12 illustrates a spatial geometric partitioning mode (“SGPM”) candidate list and a coding block as partitioned according to SGPM modes.

FIG. 13 illustrates that GPM template size is fixed to 1 according to SGPM.

FIG. 14 illustrates blending according to GPM.

FIG. 15 illustrates weight prediction according to angular weighted prediction (“AWP”).

FIG. 16 illustrates intra prediction angles according to AWP.

FIG. 17 illustrates weight array settings according to AWP.

FIG. 18A illustrates an intra prediction template including samples above and left of the current block. FIG. 18B illustrates an intra prediction template including only samples above the current block. FIG. 18C illustrates an intra prediction template including only samples left of the current block.

FIG. 19 illustrates a flowchart of signaling a first CU level flag to indicate whether SGPM mode or regression SGPM mode is used.

FIG. 20 illustrates SGPM candidates and regression SGPM candidates according to example embodiments of the present disclosure.

FIG. 21 illustrates an example system for implementing the processes and methods described above for implementing spatial geometric partitioning.

### DETAILED DESCRIPTION

Systems and methods discussed herein are directed to implementing spatial geometric partitioning for motion prediction, and more specifically including extension of regression SGPM to intra prediction; fusion SGPM with multiple intra prediction modes; adaptive blending area size for SGPM; conditional matrix-based intra prediction for SGPM; and implementing any or all of the preceding for AWP.

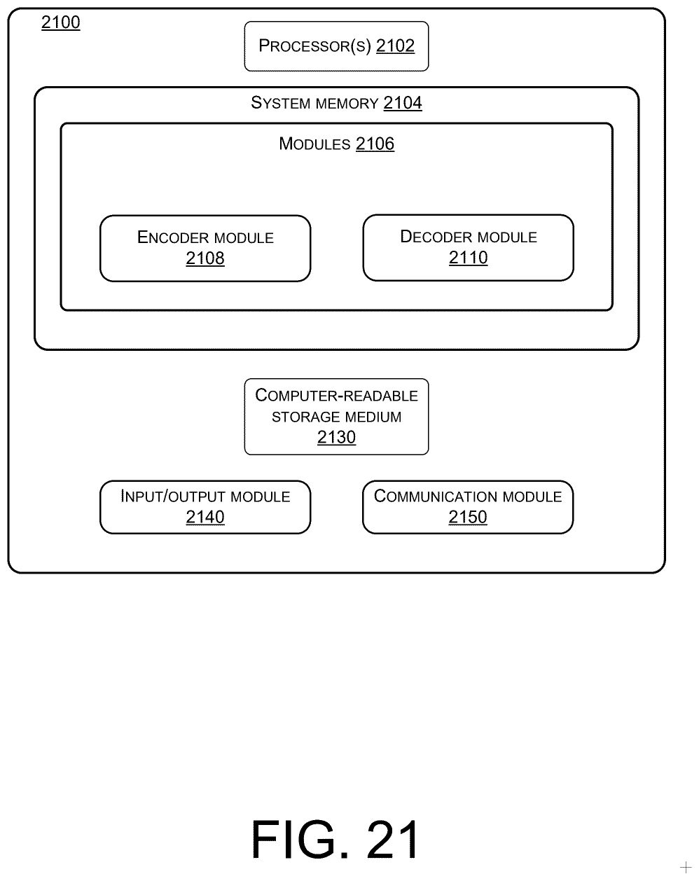

In accordance with the VVC video coding standard and successor standards currently in draft status such as H.267 (“VVC and later standards”), the AVS3 video coding standard and successor standards such as AVS4 (“AVS3 and later standards”), and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 21, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by VVC and later standards and AVS3 and later standards, and operations of a decoder as described by VVC and later standards and AVS3 and later standards. Some of these encoder operations and decoder operations according to VVC and later standards and AVS3 and later standards are subsequently described in further detail, though these subsequent descriptions should not be understood as exhaustive of encoder operations and decoder operations according to VVC and later standards and AVS3 and later standards. Subsequently, a “VVC and later standard encoder,” a “VVC and later standard decoder,” an “AVS3 and later standard encoder,” and an “AVS3 and later standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC and later standard encoder, a VVC and later standard decoder, an AVS3 and later standard encoder, and an AVS3 and later standard decoder further include computer-readable instructions stored on a computer-readable storage medium which are executable by one or more processors of a computing system to configure the one or more processors to perform operations not specified by VVC and later standards and AVS3 and later standards. A VVC and later standard encoder and an AVS3 and later standard encoder should not be understood as limited to operations of a reference implementation of an encoder, but including further computer-readable instructions configuring one or more processors of a computing system to perform further operations as described herein. A VVC and later standard decoder and an AVS3 and later standard decoder should not be understood as limited to operations of a reference implementation of a decoder, but including further computer-readable instructions configuring one or more processors of a computing system to perform further operations as described herein.

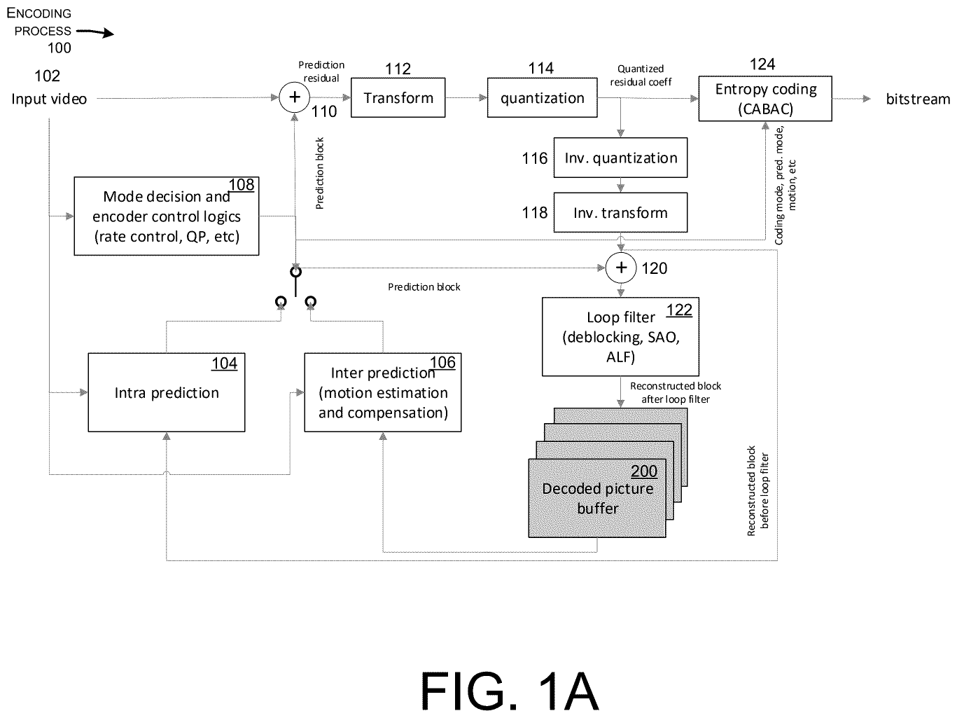

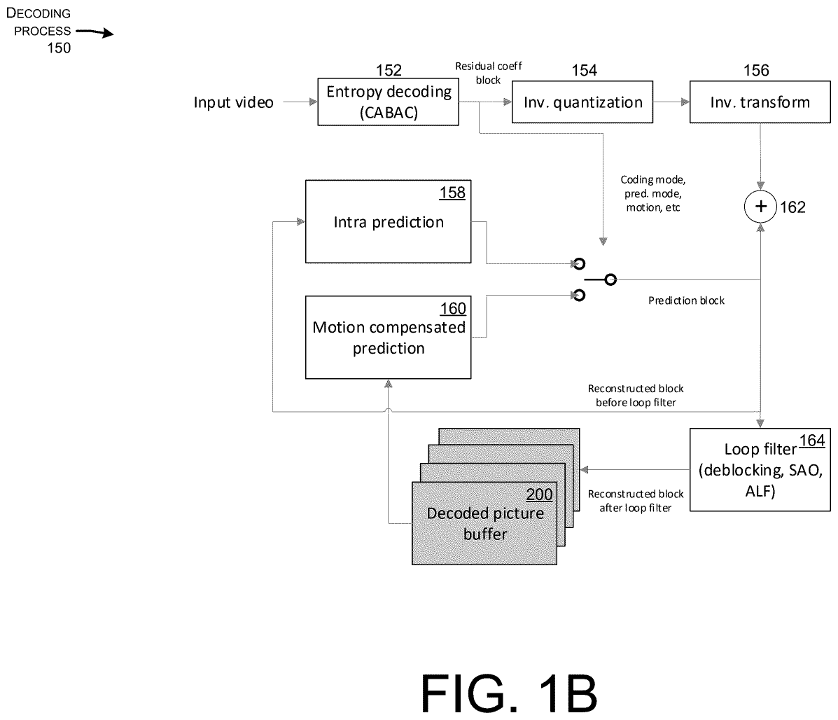

FIGS. 1A and 1B illustrate example block diagrams of, respectively, an encoding process 100 and a decoding process 150 according to an example embodiment of the present disclosure.

In an encoding process 100, a VVC and later standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC and later standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC and later standard encoder encodes a picture (a picture being encoded being called a “current picture,” as distinguished from any other picture received from an image source 102) by configuring one or more processors of a computing system to partition the original picture into units and subunits according to a partitioning structure. A VVC and later standard encoder configures one or more processors of a computing system to subdivide a picture into macroblocks (“MBs”) each having dimensions of 16×16 pixels, which can be further subdivided into partitions. A VVC and later standard encoder configures one or more processors of a computing system to subdivide a picture into coding tree units (“CTUs”), the luma and chroma components of which can be further subdivided into coding tree blocks (“CTBs”) which are further subdivided into coding units (“CUs”). Alternatively, a VVC and later standard encoder configures one or more processors of a computing system subdivide a picture into units of N×N pixels, which can then be further subdivided into subunits. Each of these largest subdivided units of a picture can generally be referred to as a “block” for the purpose of this disclosure.

A CU is coded using one block of luma samples and two corresponding blocks of chroma samples, where pictures are not monochrome and are coded using one coding tree.

A VVC and later standard encoder configures one or more processors of a computing system to subdivide a block into partitions having dimensions in multiples of 4×4 pixels. For example, a partition of a block can have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC and later standard encoder configures one or more processors of a computing system to encode color information of a picture at a lower resolution than the input picture, storing the color information in fewer bits than the input picture.

Furthermore, a VVC and later standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs can refer to a unit or multiple subunits corresponding to a block structure among multiple block structures of a picture, such as an MB or a CTU, wherein blocks are partitioned based on the picture data and are coded according to VVC and later standards. Motion information corresponding to a PU can describe motion prediction as encoded by a VVC and later standard encoder as described herein.

A VVC and later standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction can further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC and later standard encoder configures one or more processors of a computing system to code a CU to include reference indices to identify, for reference of a VVC and later standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC and later standard encoder configures one or more processors of a computing system to code each current block of a picture individually, outputting a prediction block for each. According to VVC and later standards, a CTU can be as large as 128×128 luma samples (plus the corresponding chroma samples, depending on the chroma format). A CTU can be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC and later standard encoder configures one or more processors of a computing system to send coding parameter sets such as coding mode (i.e., intra or inter prediction), a mode of intra prediction or a mode of inter prediction, and motion information to an entropy coder 124 (as described subsequently).

VVC and later standards provide semantics for recording coding parameter sets for a CU. For example, with regard to the above-mentioned coding parameter sets, pred_mode_flag for a CU is set to 0 for an inter-coded block, and is set to 1 for an intra-coded block; general_merge_flag for a CU is set to indicate whether merge mode is used in inter prediction of the CU; inter_affine_flag and cu_affine_type_flag for a CU are set to indicate whether affine motion compensation is used in inter prediction of the CU; mvp_l0_flag and mvp_1_flag are set to indicate a motion vector index in list 0 or in list 1, respectively; and ref_idx_l0 and ref_idx_l1 are set to indicate a reference picture index in list 0 or in list 1, respectively. It should be understood that VVC and later standards include semantics for recording various other information, flags, and options which are beyond the scope of the present disclosure.

A VVC and later standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC and later standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC and later standard encoder further implements a transform 112. One or more processors of a computing system are configured to perform a transform operation on the residual by a matrix arithmetic operation with a transform kernel to compute an array of coefficients (which can be referred to as “residual coefficients,” “transform coefficients,” and the like), thereby encoding a current block as a transform block (“TB”). Transform coefficients can refer to coefficients representing one of several spatial transformations, such as a diagonal flip, a vertical flip, or a rotation, which can be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC and later standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC and later standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC and later standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC and later standard encoder further implements an adder 120. One or more processors of a computing system are configured to perform an addition operation by adding a prediction block and a reconstructed residual, outputting a reconstructed block.

A VVC and later standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC and later standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC and later standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC and later standard encoder configures one or more processors of a computing system to output a coded picture, made up of coded blocks from the entropy coder 124. The coded picture is output to a transmission buffer, where it is ultimately packed into a bitstream for output from the VVC and later standard encoder. The bitstream is written by one or more processors of a computing system to a non-transient or non-transitory computer-readable storage medium of the computing system, for transmission.

In a decoding process 150, a VVC and later standard decoder configures one or more processors of a computing system to receive, as input, one or more coded pictures from a bitstream.

A VVC and later standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC and later standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC and later standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC and later standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC and later standard decoder configures one or more processors of a computing system to perform motion compensated prediction 160 using a reference picture from a DPB 200. The motion compensated prediction 160 thereby generates a prediction signal.

A VVC and later standard decoder further implements an adder 162. The adder 162 configures one or more processors of a computing system to perform an addition operation on the reconstructed residuals and the prediction signal, thereby outputting a reconstructed block.

A VVC and later standard decoder further implements a loop filter 164. One or more processors of a computing system are configured to apply a loop filter, such as a deblocking filter, a SAO filter, and ALF to a reconstructed block, outputting a filtered reconstructed block.

A VVC and later standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC and later standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC and later standard encoder and a VVC and later standard decoder each implements motion prediction coding in accordance with VVC and later standard specifications. A VVC and later standard encoder and a VVC and later standard decoder each configures one or more processors of a computing system to generate a reconstructed picture based on a previous reconstructed picture of a DPB according to motion compensated prediction as described by VVC and later standards, wherein the previous reconstructed picture serves as a reference picture in motion compensated prediction as described herein.

VVC and later standards further provide that blocks and sub-blocks of a picture can further be partitioned according to geometric partitioning for inter prediction. Square or non-square blocks and sub-blocks of size having dimensions of at least 8 luma samples to each side can be partitioned according to geometric partitioning. A partitioning mode of a block or sub-block according to geometric partitioning can be indicated by a straight partitioning line spanning a first coordinate of a first side of the block or sub-block and a second coordinate of a second side of the block.

Based on the position of the first coordinate and the position of the second coordinate, as well as orientation of the first side and orientation of the second side, an angle of the partitioning line as drawn from the first coordinate to the second coordinate, and a distance of the partitioning line as spanning the first coordinate and the second coordinate, are characterized. The angle of the partitioning line and the distance of the partitioning line can further classify the partitioning mode as one of multiple template partitioning modes which can be specified according to implementations of geometric partitioning.

Geometric partitioning modes (“GPMs”) are signaled using a CU-level flag as one kind of merge mode among other possible merge modes. In total, 64 partitions are supported by geometric partitioning mode for each possible CU size.

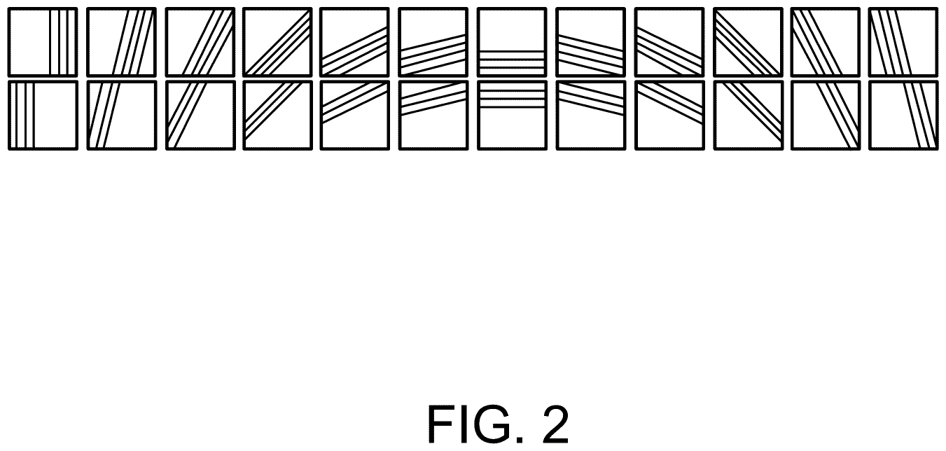

FIG. 2 illustrates classifications of geometric partitions by angle. For each classification, the splitting line always has the same angle but can be at various different coordinates, where each classification is illustrated showing, by way of example, three among many possible coordinates.

Table 1 shows the relationship between GPM split modes (merge_gpm_partition_idx) and GPM partition angles (angleIdx).

| merge_gpm_partition_idx | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

Each part of a geometric partition in the CU is inter-predicted using its own motion; only uni-prediction is allowed for each partition in VVC and later standards, i.e., each part has one motion vector and one reference index. The uni-prediction motion constraint is applied to ensure that, similar to conventional bi-prediction, only two motion compensated prediction are needed for each CU.

If GPM is applied for the current CU, then a geometric partition index indicating the split mode (corresponding to an angle and an offset), and two merge indices (one for each part) are further signaled. The number of maximum GPM candidate size is signaled explicitly in an SPS and specifies syntax binarization for GPM merge indices. After predicting each part of the geometric partition, the predicted sample values along the geometric partition edge are adjusted by a blending process with adaptive weights. This is the prediction signal for the whole CU, and transform and quantization are applied to the whole CU as in other prediction modes. Finally, the motion field of a CU predicted by GPM is stored.

According to VVC and later standards, a uni-prediction candidate list is derived directly from the merge candidate list constructed for regular merge mode. Given n as the merge index of the uni-prediction motion in the geometric uni-prediction candidate list, the list 0 or list 1 motion vector of the n-th extended merge candidate—where list 0 is used where parity of n is 0 and list 1 is used where parity of n is 1—is used as the n-th uni-prediction motion vector for geometric partitioning mode. In Table 2 below, the list 0 or list 1 motion vector of the n-th extended merge candidate as described above are marked with “x” for each n.

| | List 0 motion | List 1 motion |
|---|---|---|
| Merge index | vector | vector |
| 0 | x | |
| 1 | | x |
| 2 | x | |
| 3 | | x |
| 4 | x | |

In case a corresponding list 0 or list 1 motion vector of the n-th extended merge candidate does not exist, for list 0, the list 1 motion vector of the same candidate is used instead as the uni-prediction motion vector for geometric partitioning mode, and vice versa for list 1.

ECM provides a new uni-prediction candidate list constructed according to the following ordered steps:

Interleaved list 0 MV candidates and list 1 MV candidates are derived directly from the regular merge candidate list, where list 0 MV candidates are higher priority than list 1 MV candidates. A pruning method with an adaptive threshold based on the current CU size is applied to remove redundant MV candidates.

Interleaved list 1 MV candidates and list 0 MV candidates are further derived directly from the regular merge candidate list, where list 1 MV candidates are higher priority than list 0 MV candidates. The same pruning method with the adaptive threshold is also applied to remove redundant MV candidates.

Zero MV candidates are padded until the GPM candidate list is full.

ECM extends GPM to allow bi-predictive MVs, meaning that each part of a GPM coded block can be predicted by uni-prediction or bi-prediction. For small blocks, such as 8×8, 16×8 and 8×16 blocks, only uni-prediction is allowed and the uni-prediction candidate list as described above is used. For other larger blocks, a new merge list (which may contain bi-predictive motions) is used. The generation of the new merge list is the same as the regular merge list, except for an increased motion vector difference threshold for controlling whether a candidate can be added into the list.

According to VVC and later standards, after predicting each part of a geometric partition by reference to its own motion, blending is applied to the two prediction signals to derive samples around geometric partition splitting line. The blending weight for each position of the CU are derived based on the distance between individual position and the partition splitting line. Given indices for angle and offset of a geometric partition (represented as i, j), which depend on the signaled geometric partition index, the distance for a position (x, y) to the partition splitting line is derived according to Equation 1, Equation 2, and Equation 3 below:

$$d ( x , y ) = ( 2 x + 1 - w ) cos ( {φ}_{i} ) + ( 2 y + 1 - h ) sin ( {φ}_{i} ) - {ρ}_{j}$$

$${ρ}_{j} = {ρ}_{x , j} cos ( {φ}_{i} ) + {ρ}_{y , j} sin ( {φ}_{i} )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix}$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix}$$

The sign of ρ_{x, j} and ρ_{y, j} depend on angle index i. The weights for each part of a geometric partition are derived according to Equation 4 and Equation 5 below:

$$wIdxL ( x , y ) = partIdx ? 32 + d ( x , y ) : 32 - d ( x , y )$$

$${w}_{0} ( x , y ) = \frac{Clip 3 ( 0 , 8 , ( wIdx L ( x , y ) + 4 ) ≫ 3 )}{8}$$

$${w}_{1} ( x , y ) = 1 - {w}_{0} ( x , y )$$

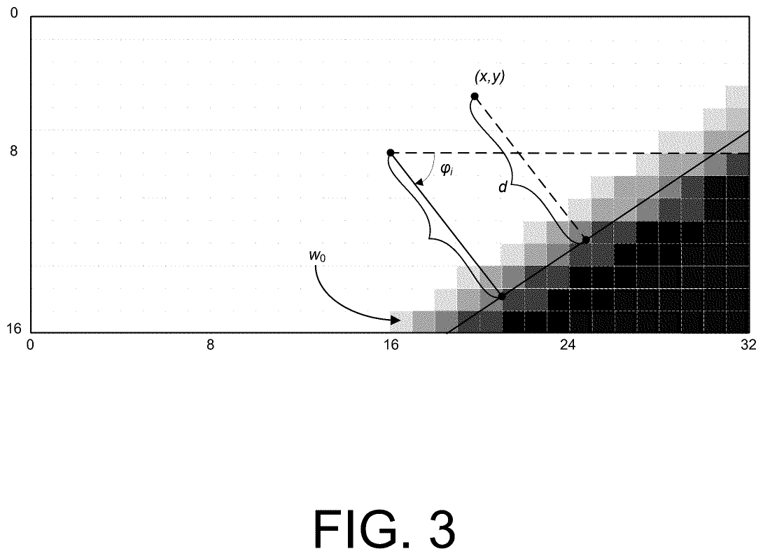

The partIdx depends on the angle index i. FIG. 3 illustrates an example blending weight w₀ derived for position (x, y).

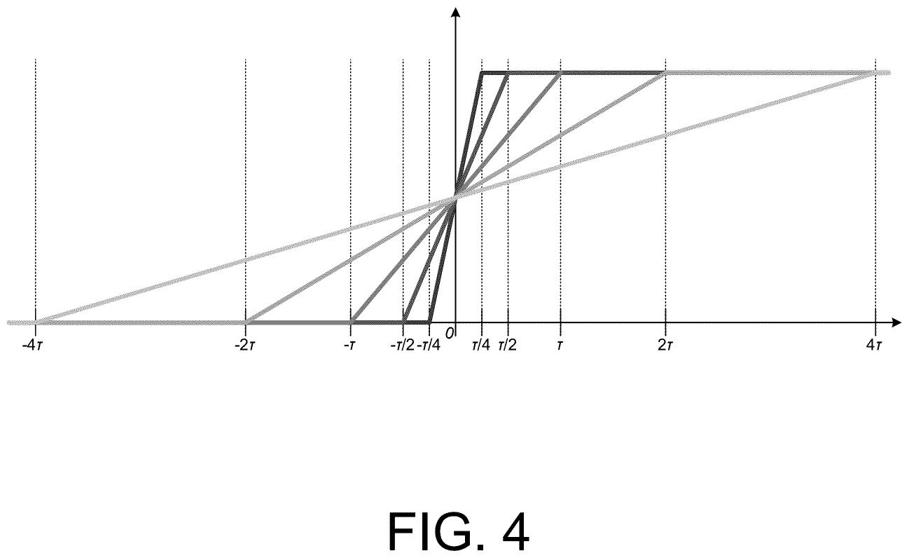

According to ECM, blending as described above is improved by adding four additional blending area sizes (quarter, half, double, and quadruple of the blending area size in VVC and later standards). A CU level flag to indicate the selected blending area size is signaled. Furthermore, extended weighting precision changes the maximum value of the weights from 8 (in VVC and later standards) to 32 to accommodate the extended blending area sizes. FIG. 4 illustrates ramp functions for additional blending area sizes based on the ramp function of an original blending area size.

ECM provides reordering of the 64 GPM split modes by template matching (“TM”). Given the motion information of the current GPM coded block, the respective TM cost values between the current template and reference template of GPM split modes are computed. Then, all GPM split modes are reordered in ascending order based on the TM cost values. Instead of signaling GPM split mode, an index using Golomb-Rice code indicates where the exact GPM split mode located in the reordering list is signaled.

GPM split mode reordering is a two-step process performed after the respective reference templates of the two GPM partitions in a coding unit are generated. The first step is extending GPM partition splitting line into the reference templates of the two GPM partitions, resulting in 64 reference templates and computing the respective TM cost for each of the 64 reference templates. The second step is reordering GPM split modes based on their TM cost values in ascending order and marking the best 32 split modes as available split modes.

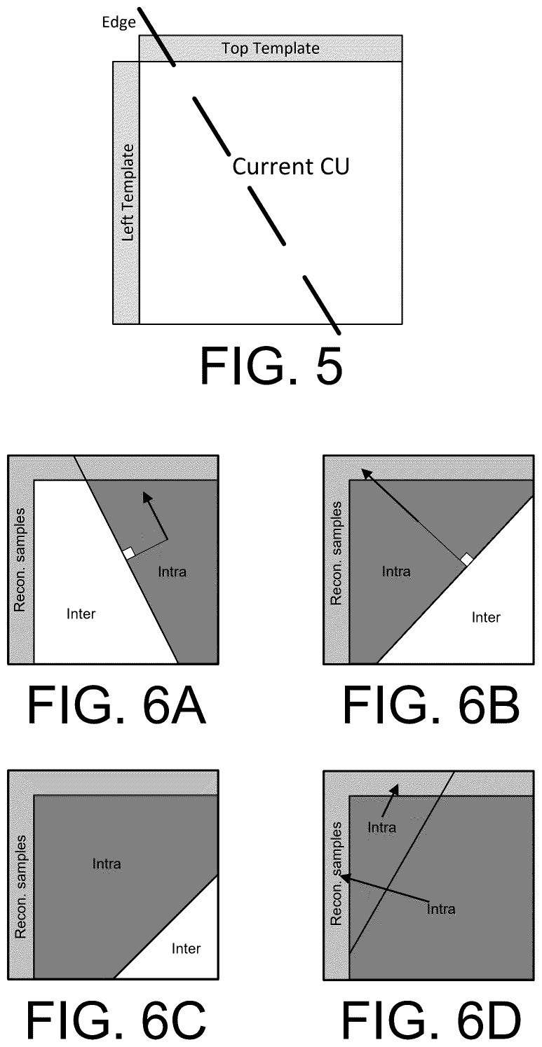

The splitting line over the template is extended from that of the current CU. FIG. 5 illustrates an example of a partition splitting line of a current CU. However, the GPM blending process is not applied in the template area across the splitting line. After ascending reordering using TM cost, an index is signaled to indicate the use of GPM split mode.

In GPM with inter and intra prediction, the final prediction samples are generated by weighting inter predicted samples and intra predicted samples for each GPM partition part. The inter predicted samples are derived by inter prediction, whereas the intra predicted samples are derived by an intra prediction mode (“IPM”) candidate list and an index signaled from the encoder. The IPM candidate list size is pre-defined as 3. FIGS. 6A through 6C illustrate respective examples of the available IPM candidates: parallel angular mode against the GPM block boundary (“Parallel mode”), perpendicular angular mode against the GPM block boundary (“Perpendicular mode”), and the Planar mode.

Furthermore, FIG. 6D illustrates GPM with intra and intra prediction, restricted to reduce the signaling overhead for IPMs and avoid an increase in the size of the intra prediction circuit on the hardware decoder. In addition, a direct motion vector and IPM storage on the GPM-blending area are introduced to further improve the coding performance.

ECM further supports a regression GPM method. Instead of signaling a split mode, two integer blending matrices (W0 and W1) are derived from a template of the current block. The template includes a line of samples above and a line of samples left of the current block. The blending matrices are modelled according to Equation 6 and Equation 7 below as an affine linear function of the sample positions (x, y) to the top-left sample in the current CU:

$$W 0 ( x , y ) = a * x + b * y + c$$

$$W 1 ( x , y ) = n - W 0 ( x , y )$$

According to some implementations, the blending matrices are modelled according to Equation 8 and Equation 9 below:

$$W 1 ( x , y ) = a * x + b * y + c$$

$$W 0 ( x , y ) = n - W 1 ( x , y )$$

where n is an positive integer value, such as, by way of example, 32.

The parameters a, b, and c in Equation 6 and Equation 8 are derived from the template by mean square error (“MSE”) minimization. Two inter predictions are applied to the template to obtain two respective predicted values of the template. Then, MSE minimization is performed to minimize the difference between the blended predicted values of the two predicted values with the two integer blending matrices and the reconstructed values of the template, and a, b, and c are optimal coefficients that minimize MSE.

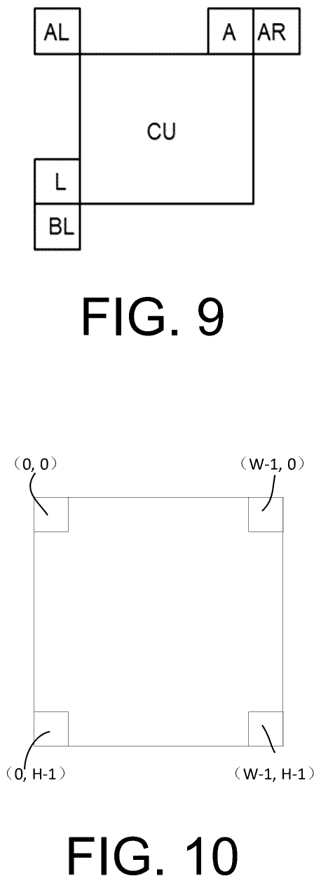

According to some implementations, regression GPM is not performed to predict the current block in the event that the blending matrices are not sufficiently informative. For example, if the absolute difference between the maximum and minimum values of W1 in the current block is less than or equal to a threshold, both blending matrices are not sufficiently informative. Alternatively, if the absolute difference between the maximum and minimum values of W1 in the four corner samples of the current block as shown in FIG. 9 is less than or equal to a threshold, both blending matrices are not sufficiently informative.

The GPM implicit mode is signaled by a CU-level flag (gpm_implicit_flag). If gpm_implicit_flag is true, a merge-idx is coded to signal the pair of GPM candidates to be used. A list of pair of candidates is built from the regular GPM candidates and reordered with the template cost. For each pair of candidates, the motion information of the two candidates is used to predict the template and two integer blending matrices (W0 and W1) are derived from the template. Then, the template cost is calculated using the Sum of Absolute Difference (“SAD”) between the blended predicted values of the template obtained by blending the two predicted values with the two integer blending matrices and the reconstructed values of the template.

The pair of GPM candidates associated with the merge-idx and the corresponding blending matrices (W0 and W1) are used to predict the current block. First, the motion information of the two candidates is used to obtain two predicted values of the current block, pred0 and pred1, respectively. Then the two predicted values are blended with W0 and W1 by Equation 10 below to generate the final predicted values of the current block, pred:

$$pred ( x , y ) = ( W 0 ( x , y ) * pred 0 ( x , y ) + W 1 ( x , y ) * pred 1 ( x , y ) + offset ) ≫ shift$$

According to VVC and later standards, the luma component can be predicted by multiple intra prediction modes. These include planar mode, DC mode, angular mode, Multiple Reference Line (“MRL”) prediction mode, Intra Sub-partition (“ISP”) mode, Matrix-based Intra Prediction (“MIP”) mode and Intra Block Copy (“IBC”) mode.

ECM extends some intra prediction modes, and adds some new intra prediction modes, such as Decoder-side Intra Mode Derivation (“DIMD”) mode, Template-based Intra Mode Derivation (“TIMD”) mode, intra Template Matching (“intra TMP”) mode and Spatial Geometric Partitioning mode (“SGPM”).

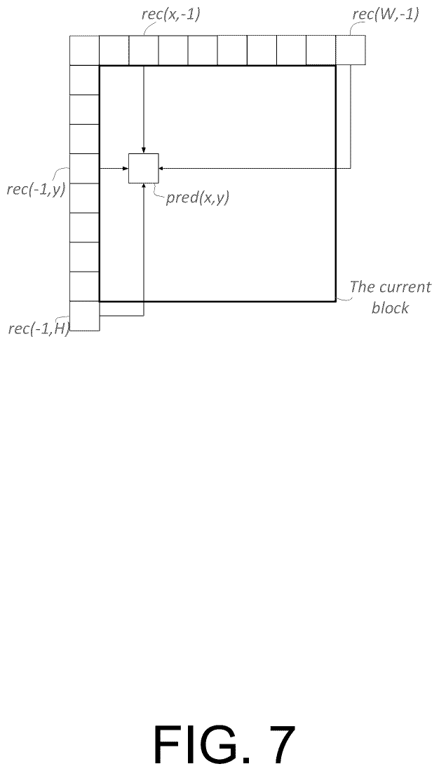

According to planar mode, the predicted value of the current sample is obtained from the reconstructed values of 4 reference samples: the left reference sample in the same row as the current sample, the above reference sample in the same column as the current sample, the reference sample on the bottom-left position adjacent to the current block and the reference sample on the above-right position adjacent to the current block. For example, given pred(x, y) as the predicted value of the current sample, H as the height of the current block, and W as the width of the current block, the reconstructed values of the four reference samples used in planar mode can be respectively represented as rec(−1, y), rec(x, −1), rec(−1, H) and rec(W, −1). FIG. 7 illustrates coordinate positions of the current sample (x, y) relative to the top-left position within the current block.

The planar mode generates the predicted value of the current sample by Equations 10, 11, and 12 below. By Equation 10, an intermediate value predV(x, y) is obtained from rec(x, −1) and rec(−1, H); by Equation 11, another intermediate value predH(x, y) is obtained from rec(−1, y) and rec(W, −1); and by Equation 12, the two intermediate values are used to generate the predicted value of the current sample.

$$predV ( x , y ) = ( ( H - 1 - y ) * rec ( x , - 1 ) + ( y + 1 ) * rec ( - 1 , H ) ) ≪ {log}_{2} W$$

$$predH ( x , y ) = ( ( W - 1 - x ) * rec ( - 1 , y ) + ( x + 1 ) * rec ( W , - 1 ) ) ≪ {log}_{2} H$$

$$pred ( x , y ) = ( predV ( x , y ) + predH ( x , y ) + W * H ) ≫ ( {log}_{2} W + {log}_{2} H + 1 )$$

The planar mode can be represented as index 0.

ECM provides two additional planar modes where only the horizontal interpolation or only the vertical interpolation are used to obtain the predicted samples for luma. For planar horizontal mode, only the horizontal linear interpolation is performed based on the left reference sample and the top-right reference sample to predict the current sample according to Equation 13 below:

$$pred ( x , y ) = ( ( W - 1 - x ) * rec ( - 1 , y ) + ( x + 1 ) * rec ( W , - 1 ) + ( W ≫ 1 ) ) ≫ {log}_{2} ( W )$$

For planar vertical mode, only the vertical linear interpolation is performed based on the above reference sample and the bottom-left reference sample to predict the current sample according to Equation 14 below:

$$pred ( x , y ) = ( ( H - 1 - y ) * rec ( x , - 1 ) + ( y + 1 ) * rec ( - 1 , H ) + ( H ≫ 1 ) ) ≫ {log}_{2} ( H )$$

DC mode generates predictions based on an average value of the left and above reference samples to the current block. In HEVC, every intra-coded block has a square shape and the length of each of its sides (i.e., left and above) is a power of 2. Thus, no division operations are required to calculate the average value. According to VVC and later standards, blocks can have a rectangular shape that necessitates the use of a division operation per block in the general case: to avoid division operations for DC prediction, only the longer side is used to compute the average value for non-square blocks, and reference samples from both left and above sides are used to compute the average value for square blocks. DC mode can be represented as index 1.

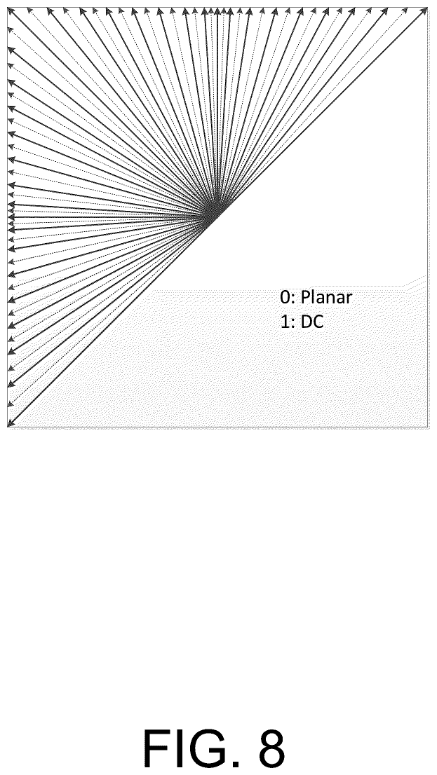

Angular intra prediction is a directional intra prediction method, which is extended from a prior implementation according to HEVC. To capture the arbitrary edge directions presented in natural video, VVC and later standards extend the number of angular intra prediction modes from 33 (as implemented in HEVC) to 65. FIG. 8 illustrates angular intra prediction modes according to VVC and later standards, where modes added in VVC and later standards are illustrated in broken lines. The 65 angle modes can be represented as index 2 to index 66 from bottom left to top right.

According to VVC and later standards, to keep the complexity of most probable mode (“MPM”) list generation low, an intra mode coding method with 6 MPMs is used by considering two available neighboring intra modes.

A unified 6-MPM list is used for intra blocks. The MPM list is constructed based on intra modes of the left and above adjacent block. Suppose the mode of the left is denoted as Left and the mode of the above block is denoted as Above, the unified MPM list is constructed as follows:

When an adjacent block is not available, its intra mode is set to Planar by default.

If both modes Left and Above are non-angular modes: MPM list→{Planar, DC, V, H, V−4, V+4}

If one of modes Left and Above is angular mode, and the other is non-angular: set a mode Max as the larger mode of either Left or Above; MPM list→{Planar, Max, Max−1, Max+1, Max−2, Max+2}

If Left and Above are both angular and they are different: set a mode Max as the larger mode of either Left or Above; set a mode Min as the smaller mode of either Left or Above; if Max−Min is equal to 1, MPM list→{Planar, Left, Above, Min−1, Max+1, Min−2}; otherwise, if Max−Min is greater than or equal to 62, MPM list→{Planar, Left, Above, Min+1, Max−1, Min+2}; otherwise, if Max−Min is equal to 2, MPM list→{Planar, Left, Above, Min+1, Min−1, Max+1}; otherwise, MPM list→{Planar, Left, Above, Min−1, −Min+1, Max−1}.

If Left and Above are both angular and they are the same: MPM list→{Planar, Left, Left−1, Left+1, Left−2, Left+2}.

ECM further introduces secondary MPM lists. The existing primary MPM (“PMPM”) list consists of 6 entries and the secondary MPM (“SMPM”) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (“L”), above (“A”), below-left (“BL”), above-right (“AR”), and above-left (“AL”) adjacent blocks, and DIMD modes which are sorted in ascending order of SAD cost. FIG. 10 illustrates adjacent blocks which can be added to MPM lists.

Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a block is vertically oriented, the order of neighboring blocks is A, L, BL, AR, AL; otherwise, it is L, A, BL, AR, AL.

ECM further provides that the intra modes of the non-adjacent blocks can also be added to the MPM list. The general MPM list (except the planar mode) is sorted by applying the intra prediction mode of each entry to a template of the current block and calculating SAD values between predicted samples and reconstructed samples of the template.

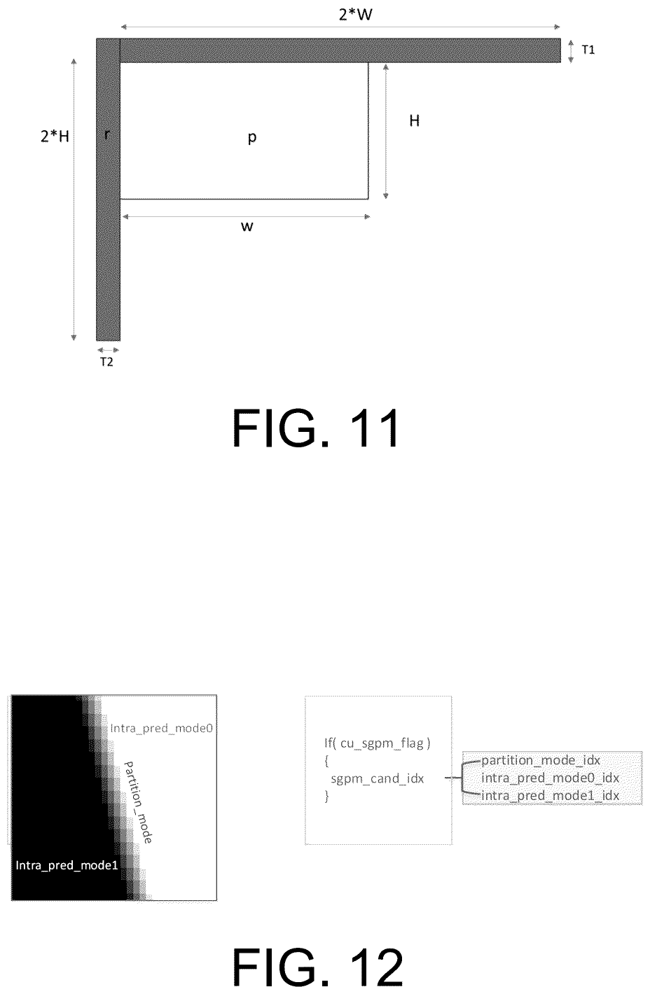

According to ECM, some of the conventional intra prediction modes (planar, DC and the 65 angular modes) may be replaced by matrix-based intra prediction modes. In a matrix-based intra prediction mode, a matrix of weights, which are defined for a block shape and intra mode index, is introduced. Those weights are multiplied by the neighbor reference template to derive the predicted values of the current block. FIG. 11 illustrates a L-shaped causal neighborhood template whose reference samples are weighted in a matrix-based intra prediction mode.

The predicted value pred(x, y) is derived by Equation 15 below, where reference samples in the causal neighborhood are denoted as r, F(x, y) is the matrix of weights, and k denotes the index of the reference sample in the template:

$$pred ( x , y ) = {\sum }_{k} F ( x , y , k ) * r ( k )$$

The prediction is applied to block sizes with both width and height up to 32 (except for 4×32, 32×4, 8×32 and 32×8). The template size is 2 for blocks with both width and height up to 16 and the modes with index 0, 1, and (2+2*k) are replaced. For other blocks, template size is set to 1 and the modes with index 0, 1, and (2+4*k) are replaced. The prediction is only performed for 16×16 positions, and the rest of the samples are generated by bilinear interpolation. For all block sizes, block shape and mode-based symmetry is used. Reference length is set to W and H for modes with index greater than 18 and less than 50, and set to 2*W and 2*H for other modes.

As mentioned above, VVC and later standards provide an IBC mode. Since IBC mode is implemented as a block level coding mode, block matching (“BM”) is performed at a VVC and later standard encoder to find the optimal block vector (or motion vector) for each CU. Here, a block vector is used to indicate the displacement from the current block to a reference block, which is already reconstructed inside the current picture. The luma block vector of an IBC-coded CU has integer precision, and the chroma block vector rounds to integer precision as well.

As mentioned above, ECM further provides a DIMD mode. Up to five intra prediction modes among angular modes are derived from the reconstructed neighbor samples, and those five predictors are combined with the planar mode predictor with the weights derived from a histogram of gradients.

As mentioned above, ECM further provides a TIMD mode. For each intra prediction mode in a list, the SATD value between the prediction and reconstruction samples of a L-shaped template is calculated. Two intra prediction modes with least SATD value are selected as the TIMD modes. These two TIMD modes are fused with SATD based weights, and such weighted intra prediction is used to code the current CU.

As mentioned above, ECM further provides a SGPM mode, utilizing GPM in intra prediction. SGPM partitions a coding block into two parts according to a partition mode and predicts each part by a intra prediction mode. The two predicted values of the two parts are blended to generate the final predicted value of the coding block. To efficiently express the partition and associated intra prediction information in the bit-stream, this method constructs a SGPM candidate list, where each candidate in the list includes a combination of a partition mode and two intra prediction modes. FIG. 12 illustrates a SGPM candidate list and a coding block as partitioned according to SGPM modes. The length of the SGPM candidate list is set equal to 16.

To build the SGPM candidate list, for each supported partition mode, a mode list is derived for each part first. The mode list includes two TIMD derived modes with horizontal and vertical orientations, the intra prediction mode associated with the partition mode, and the intra prediction modes from the adjacent blocks. The list can be further augmented with block-vector based prediction candidates obtained from the adjacent and non-adjacent blocks coded in intra TMP or IBC mode. Up to 6 block vectors are selected based on template cost. The final mode list contains up to 9 entries: 3 regular intra modes and up to 6 block vectors. The supported partition modes and the two mode lists for each part are combined in a candidate list.

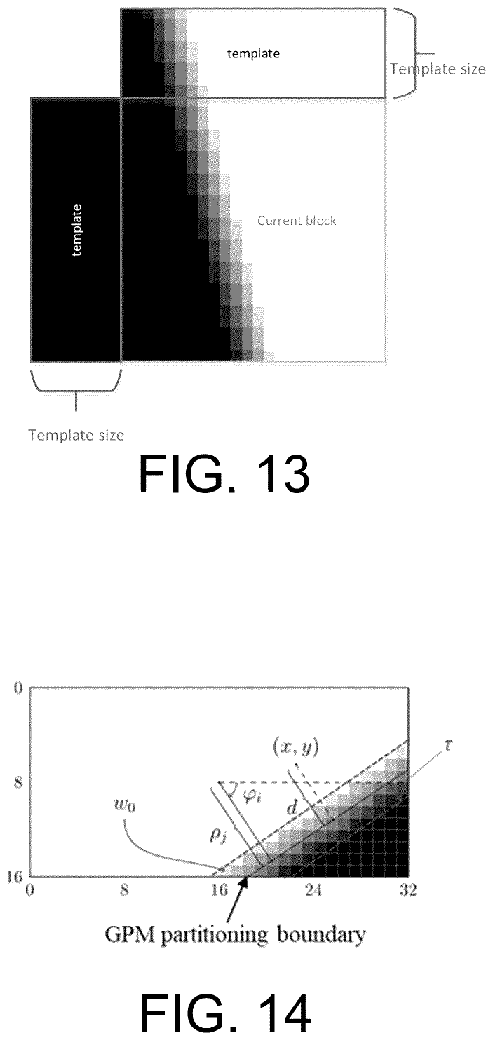

The candidates in the list are reordered by template cost, and the first 16 candidates with smallest template cost are used to construct the SGPM candidate list. For each candidate, a respective template cost is obtained by calculating the SAD between the predicted value and reconstructed value of the template. The predicted value is obtained by applying the two intra prediction modes of the candidate to the template and blending them with a weight matrix associated with the partition mode of the candidate. FIG. 13 illustrates that GPM template size is fixed to 1 according to SGPM.

The 16 candidates of a SGPM candidate list are binarized, coded, and transmitted in a bitstream using 4 bits.

The SGPM mode is applied with a restricted blocks size: 4<=width<=64, 4<=height<=64, width<height*8, height<width*8, width*height>=32.

A PPS flag is coded to allow blending of two intra predictions. When this PPS flag is set to false, the following adaptive blending is used for SGPM, where blending depth τ illustrated in FIG. 14 is derived as follows:

If min(width, height)==4, ½ τ is selected; otherwise, if min(width, height)==8, τ is selected; otherwise, if min(width, height)==16, 2 τ is selected; otherwise, if min(width, height)==32, 4 τ is selected; otherwise, 8 τ is selected.

When the PPS flag is set to true, ¼ τ is used for SGPM coded blocks, such that no blending is used when SGPM block has a horizontal or vertical partition angle, and much narrower blending width is used when SGPM block has other partition angles.

Similar to GPM in VVC and later standards, angular weighted prediction (“AWP”) is adopted in Audio Video coding Standard 3 (“AVS3”), developed by the AVS Workgroup in China. In AVS3, an angular weighted prediction mode is supported for skip and direct mode. The AWP mode is signalled using a CU-level flag as one kind of skip or direct mode. In the AWP mode, a motion vector candidate list, which contains five different uni-prediction motion vectors, is first constructed by deriving motion vectors from spatial neighboring blocks and temporal motion vector predictor. Then, two uni-prediction motion vectors are selected from the motion vector candidate list to predict the current block.

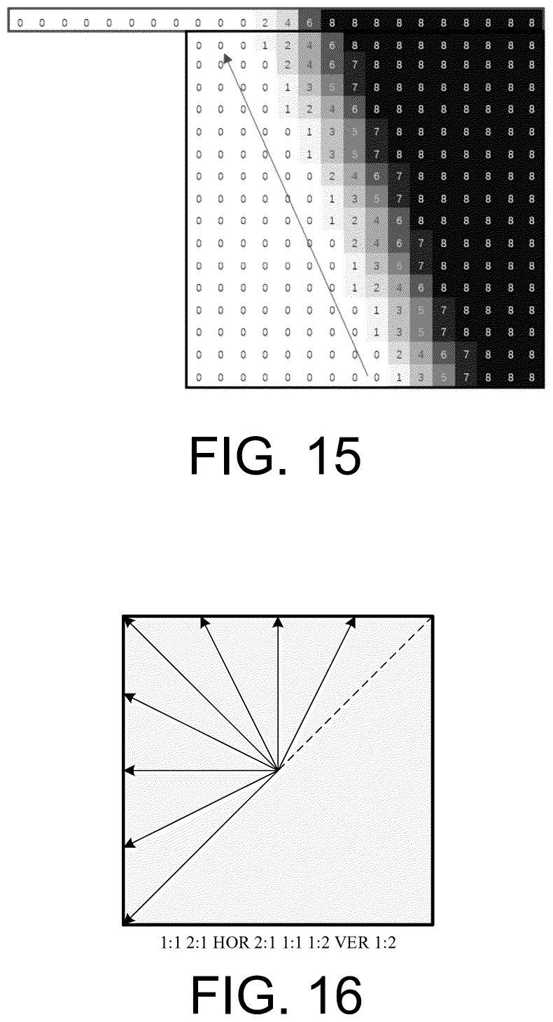

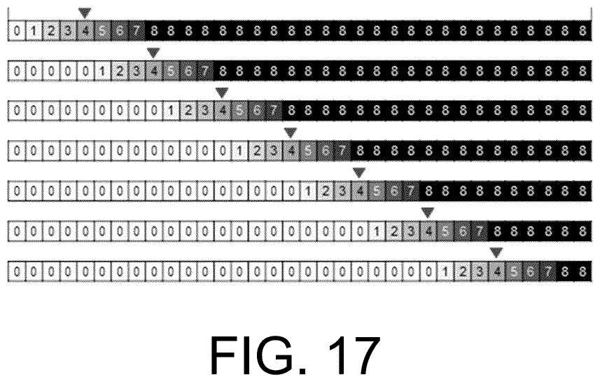

Unlike the bi-prediction inter mode where all samples are weighed equally, each sample coded in AWP mode may have different weights. The weight for each sample is predicted from a weight array which has values from 0 to 8. FIG. 15 illustrates weight prediction according to AWP, similar to the process of intra prediction mode. AWP mode supports a total of 56 different kinds of weights for each possible CU size w×h=2^{m}×2ⁿ with m, n∈{3 . . . 6}, including 8 intra prediction angles (illustrated by FIG. 16) and 7 different weight array settings (illustrated by FIG. 17). It is noted that the AWP mode is directly signaled to an AWP and later standard decoder without prediction. The AWP mode index is binarized using truncated binary: that is, index 0 to 7 are coded using 5 bits and index 8 to 55 are coded using 6 bits.

Designating the two selected uni-prediction motion vectors as Mv0 and My 1, two prediction blocks, P0 and P1, are obtained by performing motion compensation using Mv0 and Mv1, respectively. The final prediction block P is calculated by Equation 16 below:

$$P = ( P 0 \times w 0 + P 1 \times ( 8 - w 0 ) ) ≫ 3$$

where w0 is the weight matrix derived by the aforementioned weight prediction method.

After prediction, the uni-prediction motion vectors are stored at a 4×4 granularity. For each 4×4 unit, one of two uni-prediction motion vector is stored.

SGPM as implemented by ECM is presently subject to limitations such as the below:

The regression method as described above is only applied to inter GPM.

In building a SGPM candidate list according to ECM, for each supported partition mode, a mode list is derived for each part first. As mentioned above, the mode list includes two TIMD derived modes with horizontal and vertical orientations, the intra prediction mode associated with the partition mode, and the intra prediction modes from the adjacent blocks. Each mode candidate in the mode list only corresponds to a single intra prediction mode.

According to ECM, for each SGPM coded block, only one blending area is used, compared to up to 5 blending areas for inter GPM.

According to ECM, for a SGPM coded block, only conventional intra prediction is used. In contrast, conventional intra prediction is replaced by a matrix-based intra prediction based on conditions as described above.

AWP as implemented by AVS3 and later standards is subject to similar limitations.

Therefore, example embodiments of the present disclosure provide improvements to spatial geometric partitioning, including extension of regression SGPM to intra prediction; fusion SGPM with multiple intra prediction modes; adaptive blending area size for SGPM; conditional matrix-based intra prediction for SGPM; and implementing any or all of the preceding for AWP.

According to example embodiments of the present disclosure, a VVC and later standard encoder and a VVC and later standard decoder implement regression SGPM mode, in which two intra prediction modes are used to predict the current block, yielding two respective predicted values. The two predicted values of the current block generated by the two intra prediction modes are blended with two integer blending matrices which are derived by the template of the current block.

The two integer blending matrices (W0, W1) can be modelled as an affine linear function of the sample positions (x, y). By way of example, the affine linear model is as given in Equation 6 and Equation 7 above. By way of another example, the affine linear model is as given in Equation 8 and Equation 9 above. The parameters a, b, and c are derived from the template by MSE minimization. The two intra prediction modes are applied to the template to obtain two respective predicted values of the template. Then, MSE minimization is performed to minimize the difference between the blended predicted values of the two predicted values with the two integer blending matrices and the reconstructed values of the template.

The two predicted values of current block generated by the two intra prediction modes are denoted pred0 and pred1, respectively. The two predicted values are blended with W0 and W1 to generate the final predicted values of the current block, pred according to Equation 17 below:

$$pred ( x , y ) = ( W 0 ( x , y ) * pred 0 ( x , y ) + W 1 ( x , y ) * pred 1 ( x , y ) + offset ) ≫ shift$$

where offset and shift are two positive integer values which are based on n in the affine linear model. The value of offset can be half of the value of n, and the value of shift can be log₂n. By way of example, given n equal to 32, offset is equal to 16 and shift is equal to 5.

According to some example embodiments, regression SGPM is not performed to predict the current block in the event that the blending matrices are not sufficiently informative. By way of example, if the absolute difference between the maximum and minimum values of W1 in the current block is less than or equal to a threshold, both blending matrices are not sufficiently informative. By way of yet another example, if the absolute difference between the maximum and minimum values of W1 in the four corner samples of the current block shown in FIG. 9 is less than or equal to a threshold, both blending matrices are not sufficiently informative. The value of the threshold can be any positive integer, such as 4.

According to some example embodiments, if the blending matrices are not sufficiently informative, regression SGPM is still performed to predict the current block, by the generation of two default blending matrices (W0(x, y)=n/2, W1(x, y)=n/2) to blend the two intra prediction modes. The two default blending matrices can be generated by setting a=0, b=0 and c=n/2 in Equation 10 and Equation 11. By way of example, given n equal to 32, a, b, and c have values of 0, 0, and 16 respectively.

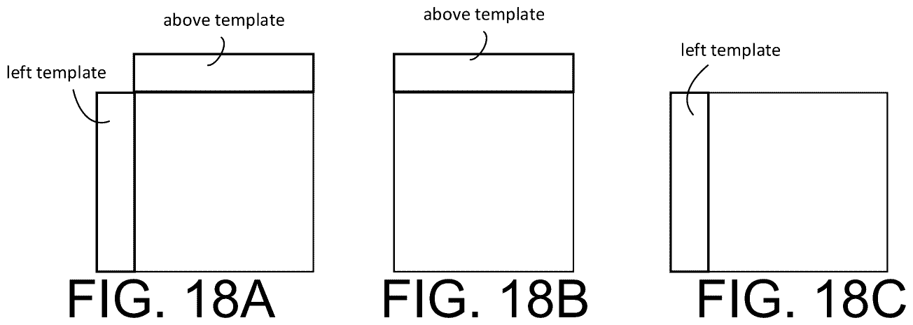

FIG. 18A illustrates an intra prediction template including samples above and left of the current block. By way of example, the template size is one line of samples above and one line of samples left of the current block. By way of another example, the template size is two lines of samples above and two lines of samples left of the current block. By way of yet another example, the template size is four lines of samples above and four lines of samples left of the current block.

FIG. 18B illustrates an intra prediction template including only samples above the current block. FIG. 18C illustrates an intra prediction template including only samples left of the current block.

According to some example embodiments, only a subset of the samples of the template are used for deriving the blending matrices. By way of example, only half of the samples of the template are used for deriving the blending matrices. By way of further examples, up to four samples, up to eight samples, up to sixteen samples, up to thirty-two samples, or up to sixty-four samples are selected from the template and used for deriving the blending matrices. These samples can be selected at regular intervals over the template, where the interval is smaller for larger numbers of samples and the interval is larger for smaller numbers of samples. By way of further example, for a larger block size of the current block, more samples of the template are used for deriving the blending matrices, and for a smaller block size of the current block, fewer samples of the template are used for deriving the blending matrices, while the samples can be selected at regular intervals over the template, and where the interval can be larger for larger block sizes and smaller for smaller block sizes, or can be the same regardless of block size.

According to a second example embodiment, a VVC and later standard encoder and a VVC and later standard decoder implement regression SGPM, extended to blend three predicted values. Three prediction modes are used to predict the current block to generate the three predicted values of the current block. Then the three predicted values are blended by three integer blending matrices derived by the template of the current block. The three integer blending matrices (W0, W1, W2) can be modelled as an affine linear function of the sample positions (x, y) to the top-left sample in the current CU according to Equation 18, Equation 19, and Equation 20 below:

$$W 0 ( x , y ) = a * x + b * y + c$$

$$W 1 ( x , y ) = d * x + e * y + f$$

$$W 2 ( x , y ) = 1 - W 0 ( x , y ) - W 1 ( x , y )$$

Denoting the three predicted values of current block generated by the three intra prediction modes as pred0, pred1 and pred2, respectively, the three predicted values are blended with W0, W1 and W2 to generate the final predicted values of the current block, pred by Equation 21 below:

$$pred ( x , y ) = ( W 0 ( x , y ) * pred 0 ( x , y ) + W 1 ( x , y ) * pred 1 ( x , y ) + W 2 ( x , y ) * pred 2 ( x , y ) + offset ) ≫ shift$$

The parameters a, b, c, d, e, and f are derived from the template by MSE minimization. The three intra prediction modes are applied to the template to obtain three respective predicted values of the template. Then, MSE minimization is performed to minimize the difference between the blended predicted values of the three predicted values with the three integer blending matrices and the reconstructed values of the template.

According to some example embodiments, the three integer blending matrices (W0, W1, W2) can be modelled as an affine linear function of the sample positions (x, y) to the top-left sample in the current CU according to Equation 22, Equation 23, and Equation 24 below:

$$W 0 ( x , y ) = 1 - W 1 ( x , y ) - W 2 ( x , y )$$

$$W 1 ( x , y ) = a * x + b * y + c$$

$$W 2 ( x , y ) = d * x + e * y + f$$

According to a third example embodiment, a VVC and later standard encoder and a VVC and later standard decoder implement signaling a CU level flag to indicate whether the regression SGPM mode is used for the current block.

FIG. 19 illustrates a flowchart of signaling a first CU level flag to indicate whether SGPM mode or regression SGPM mode is used. If the first flag is true, a second CU level flag is signaled to indicate whether the regression SGPM mode is used. If the second flag is false, the SGPM mode is used and a SGPM candidate list is constructed and a first index is signaled to indicate which SGPM candidate in the list is used. If the second flag is true, the regression SGPM mode is used, and a regression SGPM candidate list is constructed and a second index is signaled to indicate which regression SGPM candidate in the list is used. The length of the SGPM candidate list is n1, and the length of the regression SGPM candidate list is n2.

The values of n1 and n2 can be any positive integers. By way of example, both n1 and n2 are equal to 16. By way of another example, n1 is equal to 16 and n2 is equal to 8.

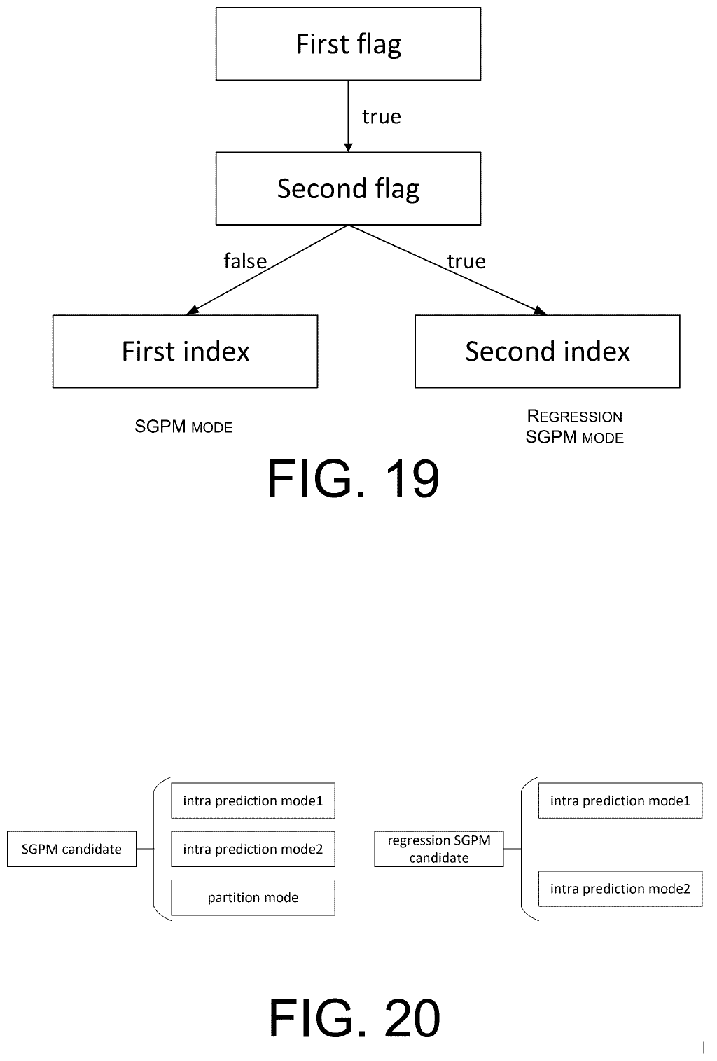

According to a fourth example embodiment, a VVC and later standard encoder and a VVC and later standard decoder implement augmenting the SGPM candidate list with regression SGPM candidates. FIG. 20 illustrates SGPM candidates and regression SGPM candidates according to example embodiments of the present disclosure; whereas each SGPM candidate includes a combination of a partition mode and two intra prediction modes, each regression SGPM candidate includes two intra prediction modes. The respective candidates are collectively reordered, and the first m candidates with least template cost can be saved to form a new combined SGPM candidate list.

The value of m can be any positive integer. By way of example, m is equal to 16. By way of further examples, m can be equal to 32, 8, or 4.

In this combined SGPM candidate list, three reordering results are possible: 1) there are only SGPM candidates in the combined SGPM candidate list; 2) there are only regression SGPM candidates in the combined SGPM candidate list; 3) there are SGPM candidates and regression SGPM candidates in the combined SGPM candidate list.

For each SGPM candidate, one partition mode and two intra prediction modes are related, and template cost is obtained by calculating SAD between the predicted value and reconstructed value of the template. The predicted value is obtained by applying the two intra prediction modes of the candidate to the template and blending them with a weight matrix associated with the partition mode of the candidate.

For each regression SGPM candidate, two intra prediction modes are related, and two integer blending matrices can be derived by the template. Template cost is obtained by calculating SAD between the predicted value and reconstructed value of the template. The predicted value is obtained by applying the two intra prediction modes of the candidate to the template and blending them with the derived integer blending matrices.

According to some example embodiments, in the combined SGPM candidate list, the number of SGPM candidates is fixed to m1 and the number of the regression SGPM candidates is fixed to m2. The SGPM candidates are reordered and only the first m1 SGPM candidates having least template cost are selected to form the combined SGPM candidate list. The regression SGPM candidates are reordered and only the first m2 regression SGPM candidates having least template cost are selected to form the combined SGPM candidate list. By way of example, m1 is equal to 8 and m2 is equal to 8. By way of another example, m1 is equal to 12 and m2 is equal to 4. In another example, m1 is equal to 16 and m2 is equal to 4.

By way of example, the combined SGPM candidate list is constructed by placing the reordered regression SGPM candidates before the reordered SGPM candidates. By way of another example, the combined SGPM candidate list is constructed by placing the reordered regression SGPM candidates after the reordered SGPM candidates.

The candidates of a combined SGPM candidate list are binarized, coded, and transmitted in a bitstream using 4 or more bits. By way of example, when m1 is equal to 16 and m2 is equal to 4, the 20 combined candidates are binarized to 5 bits.

According to some example embodiments, the number of candidates in the list is related to the block size.

According to some example embodiments, when calculating the template cost of a regression SGPM candidate, no blending is performed to the template. For example, the two prediction modes of the candidate are used to predict the template, and the predicted values are predTM0(x, y) and predTM1(x, y). The two derived integer blending matrices are W0 and W1. The two predicted values of the template can be blended with the blending matrices to generate the final predicted value predTM(x, y) of the template by Equation 25 below. If there is no blending, then the final predicted value predTM(x, y) of the template is calculated by Equation 26 below. The final predicted value predTM(x, y) is used to calculate the SAD between reconstructed value of the template.

$$predTM ( x , y ) = ( W 0 ( x , y ) * predTM 0 ( x , y ) + W 1 ( x , y ) * predTM 1 ( x , y ) + offset ) ≫ shift$$

$$predTM ( x , y ) = \{ \begin{matrix}predTM 0 ( x , y ) , & if W 0 ( x , y ) \geq W 1 ( x , y ) \\ predTM 1 ( x , y ) , & if W 0 ( x , y ) < W 1 ( x , y )\end{matrix}$$

According to a fifth example embodiment, a VVC and later standard encoder and a VVC and later standard decoder implement generating the regression SGPM candidates by selecting two intra prediction modes from MPM lists. By way of example, two intra prediction modes are selected from the general MPM list. By way of another example, two intra prediction modes are selected from the general MPM list and one or more secondary MPM lists.

According to some example embodiments, a pruning method is used to exclude possible regression SGPM candidates, so that some intra modes in the MPM lists will not be used to generate a regression SGPM candidate. For example, if the intra mode indices of two intra modes in the general MPM list are different by 1 or different by 2, then either one or the other of the intra modes will not be used to generate a regression SGPM candidate.

According to some example embodiments, the regression SGPM candidates can be further selected from any of the DIMD modes provided by ECM.

According to some example embodiments, the regression SGPM candidates can be further selected from block-vector based prediction candidates obtained from the adjacent and non-adjacent blocks coded in intra TMP or IBC mode. Then, a regression SGPM candidate can correspond to two intra prediction modes from an intra prediction mode list, and can include block vectors of these adjacent and non-adjacent blocks. Each intra prediction mode is one of planar mode, DC mode, and the 65 angular prediction modes.

According to a sixth example embodiment, a VVC and later standard encoder and a VVC and later standard decoder implement generating a propagated intra prediction mode to select the transform kernel if a CU is coded by regression SGPM mode. By way of example, a gradient of the predicted values of the current block is computed as described below to generate the propagated intra prediction mode. By way of another example, the sum of the weights for each intra prediction modes associated to the regression SGPM mode is calculated, and the mode with the larger sum of weights is used as the propagated intra prediction mode.

In one example, a CU level flag is signaled to indicate whether SGPM is used to the current block. If the flag is true, a combined SGPM candidate list is constructed and an index is further signaled to indicate which candidate in the combined SGPM candidate list is used to predict the current block. All the SGPM candidates and regression SGPM candidates are reordered and the first 16 candidates with the smallest template cost are used to construct the combined SGPM candidate list. The template includes one line of samples above and one line of samples left of the current block. Each regression SGPM candidate corresponds to two intra prediction modes. The two intra prediction modes are selected from the first MPM list and up to 6 block vectors from adjacent and non-adjacent blocks.

For a regression SGPM candidate, two weight matrices, which can be modelled as an affine linear function by Equation 8 and Equation 9 above, are derived by the template.

When a regression SGPM candidate is selected, two predicted values of the current block are generated by the two intra prediction modes associated to the regression SGPM candidate and blended with the derived weight matrices to generate the final predicted value of the current block. A gradient of the predicted value of the current block is computed to derive the propagated intra prediction mode of a regression SGPM candidate coded block. By way of example, DIMD is applied to the predicted value of the current block, causing a gradient of the predicted value of the current block to be computed.

According to example embodiments of the present disclosure, a VVC and later standard encoder and a VVC and later standard decoder implement SGPM fusion with multiple intra prediction modes.

According to a first example embodiment, a VVC and later standard encoder and a VVC and later standard decoder implement coding each part of SGPM with more than one intra prediction mode. These intra prediction modes are blended to generate the predicted value of the part. Then, the blended predicted values of the two parts are further blended according to the partition mode to generate the final predicted value of the current block.

Each mode candidate in the mode list can correspond to more than one intra prediction mode. When construct a SGPM candidate, these intra prediction modes are blended to predict a part of a block. By way of example, for the TIMD derived mode, the first two intra prediction modes with the smallest template cost are saved and the blending weights can be associated to the template cost; for intra prediction mode from an adjacent block, if the adjacent block is predicted by more than one prediction modes, all the prediction modes with their blending weights are inherited. By way of another example, if the adjacent block is predicted by more than one prediction modes, only the first two prediction modes with their blending weights are inherited.

According to a second example embodiment, a VVC and later standard encoder and a VVC and later standard decoder implement blending the predicted values of two SGPM candidates to generate the final predicted value of the current block.

By way of example, after signaling the index associated with an SGPM candidate, another index is signaled to indicate another SGPM candidate in the SGPM candidate list. Then, the two respective SGPM candidates are respectively used to predict the current block, and the predicted values of two SGPM candidates are blended to generate the final predicted value of the current block.

By way of another example, after signaling the index associated with an SGPM candidate, another flag is signaled to indicate whether to blend with another SGPM candidate. If the flag is true, another index is signaled to indicate another SGPM candidate in the SGPM candidate list.

By way of yet another example, after signaling the index associated with an SGPM candidate, another flag is signaled to indicate whether to blend with another SGPM candidate. If the flag is true, the other SGPM candidate is the first SGPM candidate in the list. In another example, the other SGPM candidate is the SGPM candidate before the selected SGPM candidate in the list. In another example, the other SGPM candidate is the SGPM candidate after the selected SGPM candidate in the list.

By way of yet another example, a flag is signaled to indicate whether two SGPM candidates are blended. If the flag is true, a blended SGPM candidate list is constructed. Each candidate in the blended SGPM candidate list corresponds to two SGPM candidates, and an index is further signaled to indicate which candidate in the blended SGPM candidate list is selected. The two SGPM candidates related to the blended SGPM candidate are used to predict the current block.

According to example embodiments of the present disclosure, a VVC and later standard encoder and a VVC and later standard decoder implement adaptive blending area size for SGPM.

According to a first example embodiment, the used blending area size is selected as following:
If min(width, height)==4, ½ τ is selected; otherwise, if min(width, height)==8, τ is selected; otherwise, if min(width, height)==16, 8 τ is selected; otherwise, if min(width, height)==32, 8 τ is selected; otherwise, 8 τ is selected.

According to a second example embodiment, an index is signaled to indicate which of the 6 blending area sizes is used. The order of the blending area sizes is different for different block sizes. By way of example:
If min(width, height)==4, the order is {½τ, τ, ¼τ, 2τ, 8τ, 4τ}; otherwise, if min(width, height)==8, the order is {τ, 2τ, ½τ, 4τ, 8τ, ¼τ}; otherwise, if min(width, height)==16, the order is {8τ, 4τ, 2τ, τ, ½τ, ¼τ}; otherwise, if min(width, height)==32, the order is {8τ, 4τ, 2τ, τ, ½τ, ¼τ}; otherwise, the order is {8τ, 4τ, 2τ, τ, ½τ, ¼τ}.

According to a third example embodiment, a flag is signaled to indicate which of the 2 blending area sizes is used. The order of the blending area sizes is different for different block sizes. By way of example:
If min(width, height)==4, the order is {½τ, τ}; otherwise, if min(width, height)==8, the order is {τ, 2τ}; otherwise, if min(width, height)==16, the order is {8τ, 4τ}; otherwise, if min(width, height)==32, the order is {8τ, 4τ}; otherwise, the order is {8τ, 4τ}.

By way of another example:
If min(width, height)==4, the order is {½τ, τ}; otherwise, if min(width, height)==8, the order is {τ, 2τ}; otherwise, if min(width, height)==16, the order is {2τ, 8τ}; otherwise, if min(width, height)==32, the order is {4τ, 8τ}; otherwise, the order is {8τ, 4τ}.

According to example embodiments of the present disclosure, a VVC and later standard encoder and a VVC and later standard decoder implement conditional matrix-based intra prediction for SGPM.

According to a first example embodiment, a VVC and later standard encoder and a VVC and later standard decoder implement replacing, conditionally, conventional intra prediction for a SGPM coded block by matrix based intra prediction. Denote the two intra prediction modes associated with the selected SGPM candidate as mode1 and mode2. If mode1 satisfies the conditions, mode1 will be replaced; if mode2 satisfies the conditions, mode2 will be replaced; if both mode1 and mode2 satisfy the conditions, both will be replaced.

According to example embodiments of the present disclosure, an AVS3 and later standard encoder and an AVS3 and later standard decoder implement any or all of the preceding example embodiments as applied to AWP in analogous fashions.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 21 illustrates an example system 2100 for implementing the processes and methods described above for implementing spatial geometric partitioning.

The techniques and mechanisms described herein may be implemented by multiple instances of the system 2100 as well as by any other computing device, system, and/or environment. The system 2100 shown in FIG. 21 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 2100 may include one or more processors 2102 and system memory 2104 communicatively coupled to the processor(s) 2102. The processor(s) 2102 may execute one or more modules and/or processes to cause the processor(s) 2102 to perform a variety of functions. In some embodiments, the processor(s) 2102 may include a central processing unit (“CPU”), a graphics processing unit (“GPU”), both CPU and GPU, or other processing units or components known in the art. Additionally, each of the processor(s) 2102 may possess its own local memory, which also may store program modules, program data, and/or one or more operating systems.

Depending on the exact configuration and type of the system 2100, the system memory 2104 may be volatile, such as RAM, non-volatile, such as ROM, flash memory, miniature hard drive, memory card, and the like, or some combination thereof. The system memory 2104 may include one or more computer-executable modules 2106 that are executable by the processor(s) 2102.

The modules 2106 may include, but are not limited to, one or more of an encoder 2008 and a decoder 2110.

The encoder 2108 may be a VVC and later standard encoder or an AVS3 and later standard encoder implementing any, some, or all aspects of example embodiments of the present disclosure as described above, and executable by the processor(s) 2102 to configure the processor(s) 2102 to perform operations as described above.

The decoder 2110 may be a VVC and later standard encoder or an AVS3 and later standard encoder implementing any, some, or all aspects of example embodiments of the present disclosure as described above, executable by the processor(s) 2102 to configure the processor(s) 2102 to perform operations as described above.

The system 2100 may additionally include an input/output (“I/O”) interface 2040 for receiving image source data and bitstream data, and for outputting reconstructed pictures into a reference picture buffer or DPB and/or a display buffer. The system 2100 may also include a communication module 2150 allowing the system 2100 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 2030, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium 2030 is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-20. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
applying a first intra prediction mode to a current coding unit (“CU”) to obtain a first predicted value;
applying a second intra prediction mode to the CU to obtain a second predicted value;
blending the first predicted value with a first integer blending matrix derived from a template of the CU and blending the second predicted value with a second integer blending matrix derived from the template to obtain a blended predicted value; and
minimizing a difference between the blended predicted value and a reconstructed value of the template.

2. The computing system of claim 1, wherein the first integer blending matrix and the second integer blending matrix are derived from an affine linear function of the template.

3. The computing system of claim 2, wherein the first integer blending matrix W0 and the second integer blending matrix W1 are derived from a sample (x, y) of the template according to the following formulae:
$$W 1 ( x , y ) = a * x + b * y + c$$
$$W 0 ( x , y ) = n - W 1 ( x , y )$$

4. The computing system of claim 3, wherein n is 32.

5. The computing system of claim 3, wherein a, b, and c are optimal coefficients that minimize the difference by mean square error (“MSE”).

6. The computing system of claim 3, wherein a, b, and c are 0, 0, and 16 and an absolute difference between maximum and minimum values of the second integer blending matrix in the CU is less than or equal to 4.

7. The computing system of claim 1, wherein the blended predicted value is obtained from the first predicted value pred0, the second predicted value pred1, the first integer blending matrix W0, and the second integer blending matrix W1 according to the following formula:
$$pred ( x , y ) = ( W 0 ( x , y ) * pred 0 ( x , y ) + W 1 ( x , y ) * pred 1 ( x , y ) + offset ) ≫ shift .$$

8. The computing system of claim 7, wherein offset is 16 and shift is 5.

9. The computing system of claim 1, wherein the first predicted value is blended with the first integer blending matrix and the second predicted value is blended with the second integer blending matrix unless an absolute difference between maximum and minimum values of the second integer blending matrix in the CU is less than or equal to 4.

10. The computing system of claim 1, wherein the first predicted value is blended with the first integer blending matrix and the second predicted value is blended with the second integer blending matrix unless an absolute difference between maximum and minimum values of the second integer blending matrix in each corner sample of the CU is less than or equal to 4.

11. The computing system of claim 1, wherein the template comprises one line of samples above and one line of samples left of the current block.

12. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
reordering SGPM candidates of a Spatial Geometric Partitioning Mode (“SGPM”) candidate list by template cost, wherein each SGPM candidate comprises a partition mode and two intra prediction modes;
reordering regression SGPM candidates by template cost, wherein each regression SGPM candidate comprises two intra prediction modes; and
selecting SGPM candidates having least template cost and regression SGPM candidates having least template cost to obtain a combined SGPM candidate list.

13. The computing system of claim 12, wherein the combined SGPM candidate list comprises sixteen SGPM candidates having least template cost and four regression SGPM candidates having least template cost.

14. The computing system of claim 12, wherein the regression SGPM candidates precede the SGPM candidates in the combined SGPM candidate list.

15. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
generating a regression Spatial Geometric Partitioning Mode (“SGPM”) candidate by selecting two intra prediction modes from a most probable mode (“MPM”) list, and block vectors of adjacent or non-adjacent block coded in intra Template Matching (“intra TMP”) mode or Intra Block Copy (“IBC”) mode.

16. The computing system of claim 15, wherein the MPM list comprises a general MPM list.

17. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
coding a current coding unit (“CU”) according to regression Spatial Geometric Partitioning Mode (“SGPM”);
computing a gradient of predicted values of the current CU to derive a propagated intra prediction mode.

18. The computing system of claim 17, wherein computing a gradient further comprises applying Decoder-side Intra Mode Derivation (“DIMD”) to predicted values of the current CU.

19. The computing system of claim 17, wherein the operations further comprise selecting a transform kernel based on the propagated intra prediction mode.

20. A non-transitory computer-readable storage medium storing a bitstream associated with a video sequence, the bitstream comprising five bits coding a combined Spatial Geometric Partitioning Mode (“SGPM”) candidate list.
